(19) United States
(12) Patent Application Publication
(10) Pub. No.: US 2014/0289761 A1
(43) Pub. Date: Sep. 25, 2014

(54) Systems and Methods of Processing Data Involving Presentation of Information on Android Devices

(71) Applicant: Blinkx, Inc., San Francisco, CA (US)

(72) Inventors: Keith Weinberger, Seattle, WA (US); Henrik Ambjoern Steen, Kirkland (US)

(73) Assignee: Blinkx, Inc., San Francisco, CA (US)

(21) Appl. No.: 14/217,130

(22) Filed: Mar. 17, 2014

Related U.S. Application Data
(60) Provisional application No. 61/799,427, filed on Mar. 15, 2013.

(51) Int. Cl. H04N 21/81; H04N 21/858; H04N 21/4725; H04N 21/482; H04N 21/435

(52) U.S. Cl. CPC H04N 21/8173; H04N 21/482; H04N 21/435; H04N 21/4725; H04N 21/858
USPC 725/32

(57) ABSTRACT

Systems and methods may display an advertisement on a mobile computing device comprising a processor and a memory. An application module coupled to the processor may be constructed and arranged to identify at least one application of the mobile computing device and store a database including at least one listing of the at least one application in the memory. A queue module coupled to the processor may be constructed and arranged to build a queue of the at least one application from the at least one listing in the database. A listener module coupled to the processor may be constructed and arranged to identify at least one broadcast event generated by the processor and associated with the at least one installed application and display at least one advertisement in response to the at least one broadcast event.

### CROSS-REFERENCE TO RELATED APPLICATION INFORMATION

This application claims benefit/priority to U.S. provisional patent application No. 61/799,427, filed Mar. 15, 2013, which is incorporated herein by reference in entirety.

### APPENDIX

This application incorporates the attached Appendices A and B of computer code and representative commands, in connection with aspects of the innovations herein may be implemented and utilized.

### BACKGROUND

Conventional advertising methods on mobile devices such as those utilizing the Android operating system rely upon application developers to call for an advertisement at specific points within the user mechanics of an application. For instance, a game application may call for an ad in between levels of a game. Another instance is for an ad to be called once the user launches or exits an application.

### OVERVIEW

The inventions herein relate to the presentation of an advertising offer immediately after a user installs an application on a mobile computing device. In some implementations, a method of displaying an advertisement on a mobile computing device is provided and includes determining reception of an operating system broadcast event output by the device indicating application installation completion, performing processing to determine an advertisement based on the received operating system broadcast event, and displaying the advertisement on the device immediately upon reception of the application installation completion associated with the operating system broadcast event.

Furthermore, the advertisement may be contextually relevant to an application associated with the application installation completion. The contextually relevant advertisement may promote a product that shares at least one characteristic with the application associated with the application installation completion. The product may be a second application that shares a same type as the application associated with the application installation completion.

In some implementations, the method includes executing the determining step, the performing step, and the displaying step as a function of a third party application to monetize the third party application. The operating system broadcast event may be output by the device to applications of the device. The determined advertisement may be requested and received from a server. The method may further include receiving user interaction with a user interface of the displayed advertisement on the device, transmitting the user interaction to a server, and storing the user interaction on the server. The broadcast event may be a package install or package added action.

In another implementation, a method of displaying an advertisement on a mobile computing device, includes determining reception of an operating system broadcast event output by the device indicating application installation completion, performing processing to determine an advertisement based on the received operating system broadcast event after application installation, and displaying the advertisement on the device prior to execution of the application associated with the operating system broadcast event signal.

Furthermore, the broadcast event may be an operating system broadcast intent. The method may include determining whether the advertisement may be displayed by interrupting control of the device. The method may include generating a queue of installed applications including an application corresponding to the application installation completion. The method may include generating a database of applications installed on the device based on the received operating system broadcast event. The advertisement may take full display screen control of the device.

The advertisement may allow user input to operate the installed application with one tap. The advertisement allows user input to download another application with one tap. The advertisement may allow user input to display a website with one tap. The advertisement may provide reminder functionality to execute the application. The reception determination step may include listening for an operating system broadcast action. The determining reception step may include listening for a broadcast intent signal. The broadcast event may be a package installed signal. The broadcast event may be an install referrer output from an application download site. The advertisement may offer an application to download from an external server. The advertisement may be any one of an offer to download another application, a banner advertisement, and a video advertisement. The displayed advertisement may be provided in a graphical user interface. The device may be an Android device.

In another implementation, a method of displaying an advertisement on a device includes determining reception of a broadcast event, determining an advertisement based on the determined broadcast event, and displaying the advertisement on the device.

In another implementation, a method of displaying an advertisement on a mobile computing device includes determining reception of an operating system broadcast event output by the device indicating application installation completion, generating a queue of installed applications including an application corresponding to the application installation completion, generating a database of applications installed on the device based on the received operating system broadcast event, and determining whether control of the device may be interrupted by full screen control of a display of the device by another application.

In another implementation, a method of displaying an advertisement on a mobile computing device includes browsing applications for download from an application server, downloading an application from the application server, broadcasting an Android operating system broadcast action indicating application installation. The method further includes executing in a third party application, listening for the Android operating system broadcast action indicating application installation, determining an advertisement that is contextually relevant to the application based on receiving the Android operating system broadcast action, retrieving the determined advertisement from an external server, and displaying the advertisement on the device immediately upon reception of the application installation associated with the operating system broadcast action. The advertisement may be displayed on a full screen of the device and include an offer to download another application contextually relevant to the downloaded application. The method may further include receiving user interaction with a user interface of the displayed advertisement on the device, transmitting the user interaction to a server, and storing the user interaction on the server, wherein the user interaction downloads the contextually relevant another application.

It is to be understood that both the foregoing general description and the following detailed description are exemplary and explanatory only and are not restrictive of the invention, as described. Further features and/or variations may be provided in addition to those set forth herein. For example, the present invention may be directed to various combinations and subcombinations of the disclosed features and/or combinations and subcombinations of several further features disclosed below in the detailed description.

### DESCRIPTION OF THE DRAWINGS

The accompanying drawings, which constitute a part of this specification, illustrate various implementations and aspects of the innovations herein and, together with the description, help illustrate the principles of the present inventions. In the drawings:

FIG. 1 is a system block diagram illustrating operation of a device consistent with certain aspects related to the innovations herein.

FIG. 2 is a sequence diagram illustrating operation of a system consistent with certain aspects related to the innovations herein.

FIG. 3 is another sequence diagram illustrating operation of a system consistent with certain aspects related to the innovations herein.

FIG. 4 is a flowchart illustrating operation of a device consistent with certain aspects related to the innovations herein.

FIG. 5 is another flowchart illustrating operation of a device consistent with certain aspects related to the innovations herein.

### DETAILED DESCRIPTION OF ILLUSTRATIVE IMPLEMENTATIONS

Reference will now be made in detail to the inventions herein, examples of which are illustrated in the accompanying drawings. The implementations set forth in the following description do not represent all implementations consistent with the claimed inventions. Instead, they are merely some examples consistent with certain aspects related to the systems and methods described herein. Wherever possible, the same reference numbers will be used throughout the drawings to refer to the same or like parts.

In connection with development functions of the Android developer tools, the systems and methods described herein listen for an Android system broadcast action that indicates an application has been installed on the device. In one embodiment the system listens for the broadcast intent named ACTION_PACKAGE_ADDED to detect when an application is installed on the device. Upon detection of such action, the system takes full screen control of the device and presents the user with advertising. The types of advertising possible within this space include offers to download related apps, banner ads, video ads and others. In another embodiment, the full screen may also display utility functions such as a one tap method to run the installed app, a method to set a reminder to run the installed app, and other functions useful to the user. This system may be developed as a standalone application or embedded in another application as a module. Some embodiments may use the specific system event associated with the installation of an app to take full screen control of the device and display an ad.

Systems and methods described herein may comprise one or more computers, which may also be referred to as processors. A computer may be any programmable machine or machines capable of performing arithmetic and/or logical operations. In some embodiments, computers may comprise processors, memories, data storage devices, and/or other commonly known or novel components. These components may be connected physically or through network or wireless links. Computers may also comprise software which may direct the operations of the aforementioned components. Computers may be referred to with terms that are commonly used by those of ordinary skill in the relevant arts, such as servers, PCs, mobile devices, routers, switches, data centers, distributed computers, and other terms. Computers may facilitate communications between users and/or other computers, may provide databases, may perform analysis and/or transformation of data, and/or perform other functions. It will be understood by those of ordinary skill that those terms used herein are interchangeable, and any computer capable of performing the described functions may be used. For example, though the term “server” may appear in the following specification, the disclosed embodiments are not limited to a server.

Computers may be linked to one another via a network or networks. A network may be any plurality of completely or partially interconnected computers wherein some or all of the computers are able to communicate with one another. It will be understood by those of ordinary skill that connections between computers may be wired in some cases (e.g., via Ethernet, coaxial, optical, or other wired connection) or may be wireless (e.g., via Wi-Fi, WiMax, or other wireless connection). Connections between computers may use any protocols, including connection oriented protocols such as TCP or connectionless protocols such as UDP. Any connection through which at least two computers may exchange data can be the basis of a network.

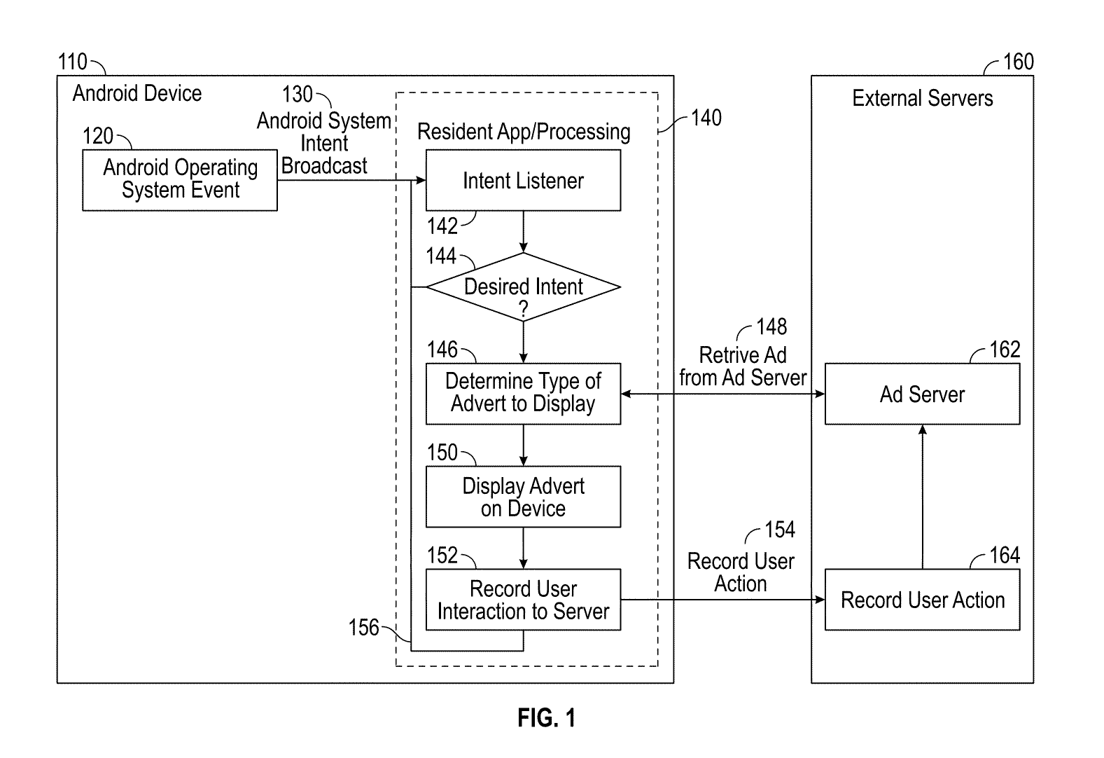

FIG. 1 is a system block diagram illustrating operation of a device consistent with certain aspects related to the innovations herein. In FIG. 1, a mobile device 110, such as an Android device, is shown broadcasting a system event, and the device may listen to the broadcast events. There may be many standard and/or custom broadcast events utilized by Android devices, as those of ordinary skill in the art will appreciate. For example, the device may listen for certain specific events, and if one is detected, the device may call out for an advertisement to display. The advertisement may be combined into a UI that may be displayed to the user. An external ad server may be called and may deliver ads in response. An external database may record user interaction with the advertisement.

FIG. 1 depicts a method of displaying an advertisement on a mobile computing device and includes determining reception of an operating system broadcast event output by the device indicating application installation completion, performing processing to determine an advertisement based on the received operating system broadcast event, and displaying the advertisement on the device immediately upon reception of the application installation completion associated with the operating system broadcast event.

The mobile device 110 may output an operating system event at step 120, for example an Android operating system intent broadcast message 130. The mobile device 110 may include a processor. A resident application 140 may be executed on the processor to perform the steps 142-156. In some embodiments, the resident application may be embedded within a third party application that performs other functions, such as a game or a utility application. At step 142, the intent listener listens to the intent broadcast 130 and determines at step 144 whether a desired intent broadcast is received. If so, the process proceeds to step 146 where a type of advertisement to display is determined. For example, the advertisement may be contextually relevant to an application associated with the application installation completion. The contextually relevant advertisement may promote a product that shares at least one characteristic with the application associated with the application installation completion. The product may be a second application that shares a same type as the application associated with the application installation completion, for example. The mobile device 110 then may retrieve an advertisement 148 from an external server 160, such as an advertisement server 162. Once an advertisement is retrieved, externally or from storage within the device 110, the advertisement may be displayed 150 on a display of the device 110. The resident application 140 may also record the user interaction 152 with the advertisement and transmit the user action 154. The user action may be recorded 164 on the external server 160.

In some embodiments, the determining step, the performing step, and the displaying step may be executed as a function of a third party application to monetize the third party application. The operating system broadcast event may be output by the device to applications of the device. The determined advertisement may be requested and received from a server. The broadcast event may be a package install or package added action.

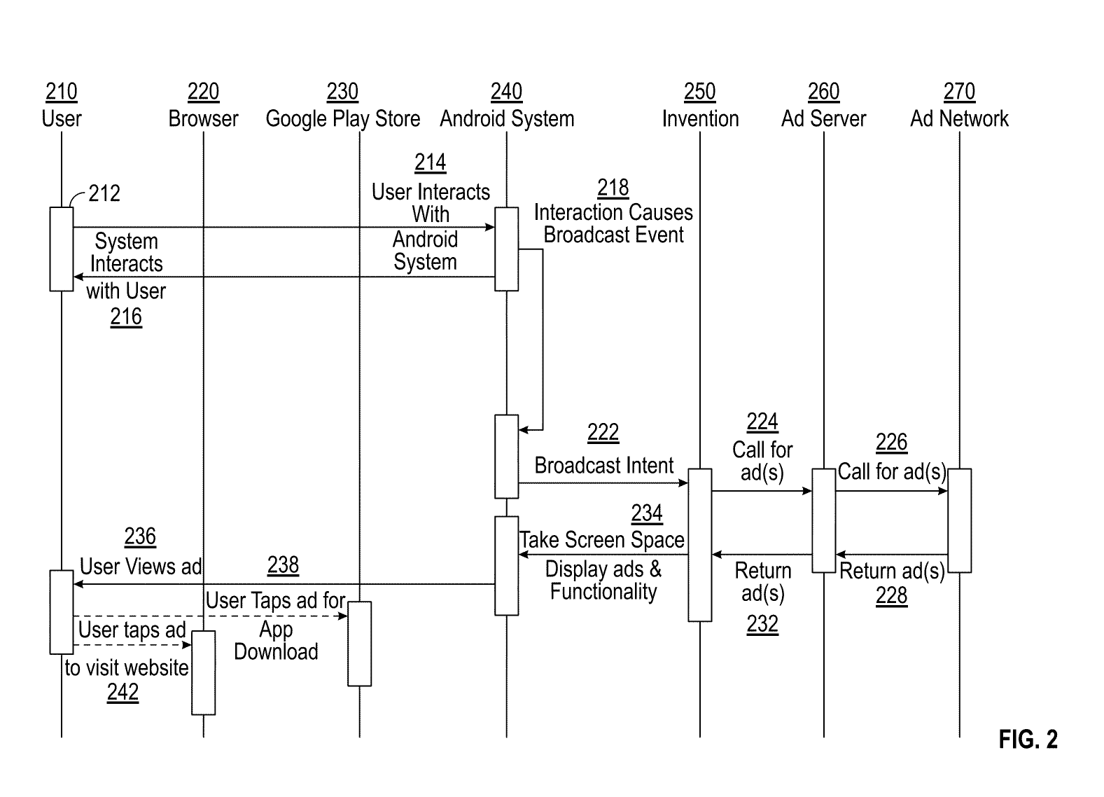

FIG. 2 is a sequence diagram illustrating operation of a system consistent with certain aspects related to the innovations herein. As shown in FIG. 2, displaying an advertisement on a mobile computing device may include determining reception of an operating system broadcast event output by the device indicating application installation completion, performing processing to determine an advertisement based on the received operating system broadcast event after application installation, and displaying the advertisement on the device prior to execution of the application associated with the operating system broadcast event signal.

Furthermore, the broadcast event may be an operating system broadcast intent. The method may include determining whether the advertisement may be displayed by interrupting control of the device. The method may include generating a queue of installed applications including an application corresponding to the application installation completion. The method may include generating a database of applications installed on the device based on the received operating system broadcast event. The advertisement may take full display screen control of the device.

FIG. 2 shows a sequence of events that may occur in a system including a user 210, internet browser 220 on the device, the Google Play Store 230, the Android system 240, the system/methods described herein 250, advertisement server 260, and an advertisement network 270. The sequence starts with the user 210 interacting 214 with the Android system of the mobile device 110. The interaction may cause a broadcast event 218 to be sent by the mobile device 110. The broadcast event may be a package installed signal or an install referrer output from an application download site, for example. In response, a broadcast intent 222 may be transmitted, and the system/methods described herein may listen to the broadcast intent and call to an advertisement server 260 for an advertisement 224. The advertisement server 260 may call for an advertisement from the advertisement network 270. The advertisement network 270 may return an advertisement 228 to the advertisement server 260, and the advertisement server 260 may send the advertisement to the mobile device at step 232. A graphical user interface (GUI) may be presented to the user at step 234. The GUI may take control of the display screen space, display the advertisement, and provide any associated functionality with the advertisement. The advertisement may be displayed to the user at step 236, and when the user interacts 238 with the advertisement, the user may initiate functionality to visit a website 242, to download a different application, and/or other functionality.

In some embodiments, the advertisement may allow user input to operate the installed application with one tap. The advertisement may allow user input to download another application with one tap. The advertisement may allow user input to display a website with one tap. The advertisement may provide reminder functionality to execute the application. The advertisement may offer an application to download from an external server. The advertisement may be any one of an offer to download another application, a banner advertisement, and a video advertisement. The displayed advertisement may be provided in a graphical user interface.

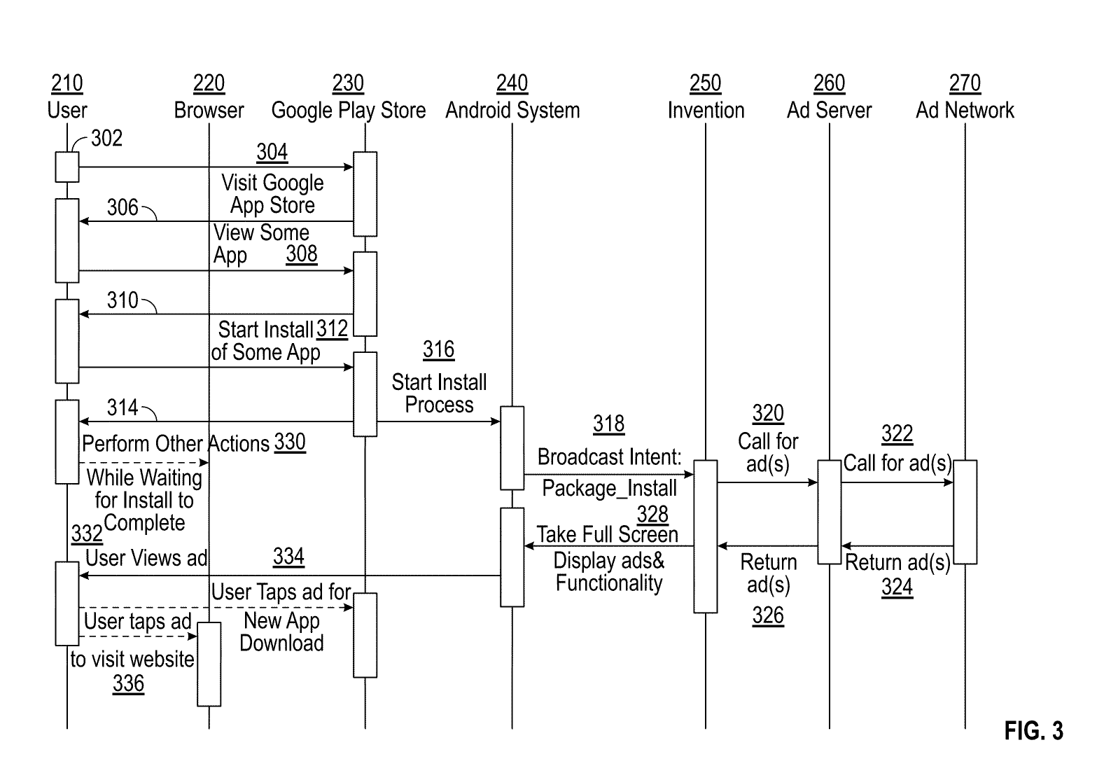

FIG. 3 is a sequence diagram illustrating operation of a system consistent with certain aspects related to the innovations herein. This diagram shows one embodiment in which the specific broadcast event named “PACKAGE_INSTALL” is detected and operated upon. PACKAGE_INSTALL may be broadcast by the Android operating system when a new application completes installation on the device.

FIG. 3 illustrates the sequence of events occurring in a system including a user 210, internet browser 220 on the device 110, the Google Play Store 230, the Android system 240, the system/methods described herein 250, advertisement server 260, and an advertisement network 270. The sequence starts with the user 210 interacting 302 with the Android system of the mobile device to transmit 302 and receive 306 data from an application store. The user may select to view information on applications 308 and may receive corresponding data 310 from the application store. The user may select to start installation of an application 312, and the user may receive an indication 314 of application selection. The application store then may communicate with the operating system 240 to start the installation process 316. The user may perform other actions at step 330 while waiting for installation of the selected application to complete. The operating system 240 may transmit a broadcast intent signal such as PACKAGE_INSTALL at step 318. The system/methods described herein may listen to the broadcast intent and call to an advertisement server 260 for an advertisement 320. The advertisement server 260 may call for an advertisement 322 from the advertisement network 270. The advertisement network 270 may return an advertisement 324 to the advertisement server 260, and the advertisement server 260 may send the advertisement to the mobile device at step 326. A GUI may be presented to the user at step 234. The GUI may take control of the display screen space, display the advertisement, and provide any associated functionality with the advertisement. The advertisement may be displayed to the user at step 236, and when the user interacts 238 with the advertisement, the user may initiate functionality to visit a website 242, to download a different application, and/or other functionality.

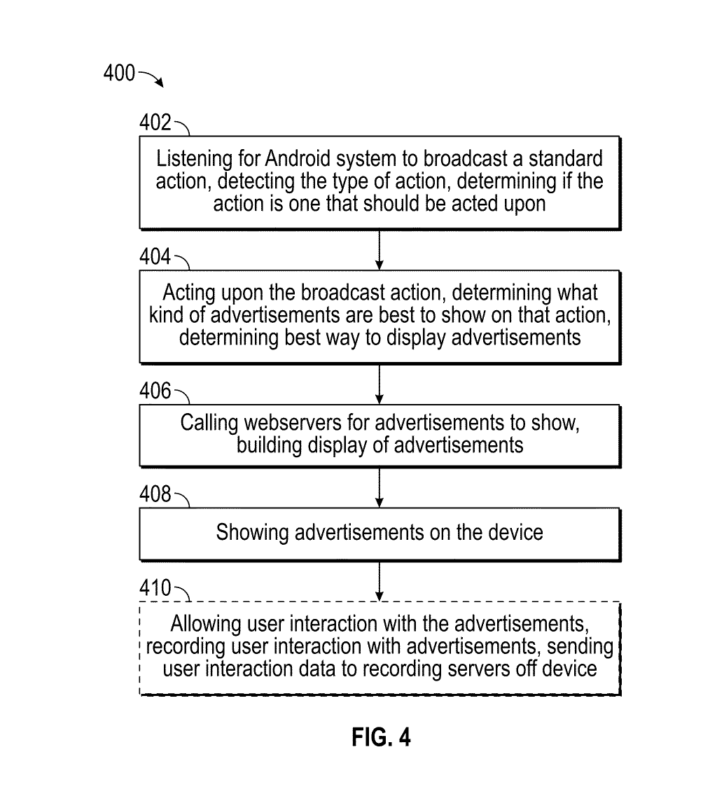

FIG. 4 is a flowchart illustrating operation 400 of a device consistent with certain aspects related to the innovations herein. This example operation may be performed with an Android device. The system may listen for broadcast events sent by the Android operating system and determine if an event should be acted upon. If so, an advertisement to show to the user may be produced by calling for an ad from an external server and determining the best way to show the advertisement. The advertisement may be shown to the end user, and the end user's interaction with the advertisement may be recorded.

At step 402, the device 110 may for the Android system to broadcast a standard action, detect the type of action, and determine if the action is one that should be acted upon. If the action should be acted upon, in step 404 the device 110 may determine what kind of advertisements should be shown, given the action in question. The device 110 may also determine the way to display advertisements. In step 406, webservers may be called for advertisements, and the advertisements may be built for display. At step 408, the advertisements may be shown on the device. In step 410, user interaction with the advertisements may be allowed. The user interaction with advertisements may be recorded, and user interaction data may be sent to external recording servers.

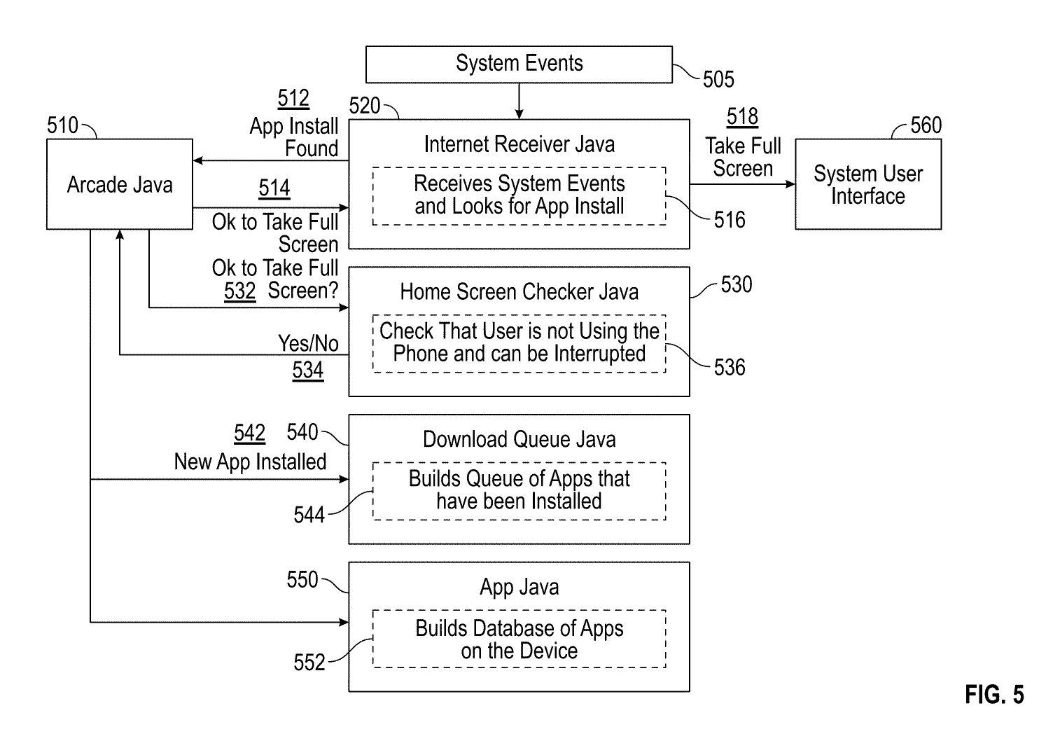

FIG. 5 is a flowchart illustrating operation of a device consistent with certain aspects related to the innovations herein. In particular, FIG. 5 describes a processing by code module. A main code module may be provided. For example, in FIG. 5, Arcade.java 510 is the main code module. Arcade.java 510 may manage the application's set up and loading of resources and other code modules for proper operation on the mobile device 110. Once loaded and running on the device, the other code modules may function as follows.

Module App.java 550 may build and maintain a database of apps 552 that reside on the device. The database may be referenced by the DownloadQueue.java 540 module to determine if an application should be displayed in the device's interface. The determination may be based on whether the application has already been run by the user or not, for example. When a new application is installed, Arcade.java 510 may transmit 542 to DownloadQueue.java 540 and App.Java 550 that a new application has been installed. DownloadQueue.Java 540 may build a queue of applications that have been installed 544.

A listener module, e.g., IntentReceiver.java 520, may listen for, receive, and processes system events 505 that are broadcast by the Android operating system. The broadcast event may be an operating system broadcast intent, for example. IntentReceiver.java 520 may look for system events 516 that can be used to trigger the call and display for an advertisement. In some implementations, IntentReceiver 520 may look for a system event 516 that means a new application has been installed on the device, for example. IntentReceiver.java 520 may communicate information about a system event event 512 to Arcade.java 510.

When Arcade.java 510 receives information about a new application install event, it may cause 532 HomeScreenChecker.java 530 module to run a set of rules to determine if it is permissible 536 to display information full screen on the device and/or whether the advertisement may be displayed by interrupting control of the device. Various rules may be established to control aspects of advertisement display. For example, rules may prevent the display from interrupting a user if they are using the device as a phone, and/or rules may ensure the screen is not in screen-lock mode before showing an advertisement. Other rules useful to the end user experience may also be established.

If Arcade.java 510 receives confirmation 534 from HomeScreenChecker.java 530 that it is OK to display information for the user full screen, Arcade.java 510 may communicate a display command 514 to IntentReceiver.java 520. IntentReceiver.java 520 may take control 518 of the system user interface device screen 560 and display the application interface for the user. The application interface may provide the end user with the tools and controls to run the application that was just installed, set a reminder, and/or run other applications that were installed before but not yet run, for example. The application interface may also display advertising along with these tools and controls.

In some implementations, the advertisements are contained within the application interface using a webview and a call to a URL to retrieve a webpage containing an advertisement. In some other implementations, the advertisements may be called directly by the application and added to the application interface or displayed on the mobile device in a way congruent with the functioning of the application.

As disclosed herein, features consistent with the present inventions may be utilized via and/or involved with various circuits/circuitry, hardware, software and/or firmware. For example, the systems and methods disclosed herein may be embodied in or used in connection with various forms including, for example, memory, data processors, such as in computing devices that also includes memory, a database, digital electronic circuitry, firmware, software, or in combinations of them. Further, while some of the disclosed implementations describe specific hardware components, systems and methods consistent with the innovations herein may be implemented in the context of any combination of hardware, software and/or firmware. Moreover, the above-noted features and other aspects and principles of the innovations herein may be implemented in various memory environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data/instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media), though does not include transitory media such as carrier waves.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the inventions pertain that variations and modifications of the various implementations shown and described herein may be made without departing from the spirit and scope of the innovations herein. Accordingly, it is intended that the inventions be limited only to the extent required by the applicable rules of law.

1. A system for displaying an advertisement, the system comprising:
a mobile computing device comprising a processor and a memory;
an application module coupled to the processor, the application module constructed and arranged to identify at least one application of the mobile computing device and store a database including at least one listing of the at least one application in the memory;
a queue module coupled to the processor, the queue module constructed and arranged to build a queue of the at least one application from the at least one listing in the database; and
a listener module coupled to the processor, the listener module constructed and arranged to:
identify at least one broadcast event generated by the processor and associated with the at least one installed application, and
display at least one advertisement in response to the at least one broadcast event.

2.-18. (canceled)

19. A method for displaying an advertisement on a mobile computing device comprising a processor and a memory, the method comprising:
identifying, with an application module coupled to the processor, at least one application of the mobile computing device;
storing, with the application module, a database including at least one listing of the at least one application in the memory;
building, with a queue module coupled to the processor, a queue of the at least one application from the at least one listing in the database;
identifying, with a listener module coupled to the processor, at least one broadcast event generated by the processor and associated with the at least one installed application; and
displaying, with the listener module, at least one advertisement in response to the at least one broadcast event.

20. The method of claim 19, further comprising managing, with a main module coupled to the processor, the application module, the queue module, the listener module, a rules module coupled to the processor, or any combination thereof.

21. The method of claim 19, wherein building the queue comprises determining whether the at least one application should be displayed in an interface.

22. The method of claim 21, wherein the determining is based on whether the at least one application has been run.

23. The method of claim 22, wherein the determining is based on whether the at least one application has been installed.

24. The method of claim 19, further comprising evaluating, with a rules module coupled to the processor, the at least one broadcast event against at least one rule to determine whether the at least one advertisement can be displayed, to determine a characteristic of the at least one advertisement, or a combination thereof.

25. The method of claim 24, wherein the rule comprises whether it is permissible to display information full screen on the device, whether the advertisement may be displayed by interrupting control of the device, whether the advertisement may be displayed while the device is being used as a phone, whether the advertisement may be displayed while the device is in a screen lock mode, or any combination thereof.

26. The method of claim 19, wherein the broadcast event is a PACKAGE INSTALL.

27. The method of claim 19, wherein the broadcast event is an operating system broadcast intent.

28. The method of claim 19, further comprising storing a user interaction with the at least one advertisement in the memory.

29. The method of claim 19, further comprising storing a user interaction with the at least one advertisement in a database of a remote computer.

30. The method of claim 19, further comprising receiving at least a portion of the at least one advertisement at the device from a remote computer via a network.

31. The method of claim 19, wherein the at least one advertisement comprises one or more of the following functionalities:
functionality to visit a website;
functionality to download at least one new application;
functionality to operate the at least one application with one tap on a screen of the device;
functionality to download at least one new application with one tap on a screen of the device;
functionality to visit a website with one tap on a screen of the device;
reminder functionality; and
a graphical user interface.

32. The method of claim 19, wherein the at least one advertisement comprises a text advertisement, a graphic advertisement, a video advertisement, an audio advertisement, or a combination thereof.

33. The method of claim 19, wherein the at least one advertisement is contextually relevant to the at least one application.

34. The method of claim 33, wherein the contextually relevant advertisement promotes a product that shares at least one characteristic with the at least one application.

35. The method of claim 34, wherein the product is a second application that has a same type as the at least one application.

36. The method of claim 19, wherein the mobile computing device is an Android device.

37. One or more computer-readable media containing computer-readable instructions to cause at least one processor to process information regarding display of an advertisement on a mobile computing device, the computer-readable instructions comprising instructions for:
identifying at least one application of the mobile computing device;
storing a database including at least one listing of the at least one application in a memory;
building a queue of the at least one application from the at least one listing in the database;
identifying at least one broadcast event generated by the processor and associated with the at least one installed application; and
displaying at least one advertisement in response to the at least one broadcast event.
